(19) United States
(12) Patent Application Publication
(10) Pub. No.: US 2025/0075538 A1
(43) Pub. Date: Mar. 6, 2025

(54) Slot and Tab Door Latch

(71) Applicant: Jeffrey J. Schwank, Sterling, IL (US)

(72) Inventor: Jeffrey J. Schwank, Sterling, IL (US)

(73) Assignee: Bonnell Industries, Inc., Dixon, IL (US)

(21) Appl. No.: 18/602,450

(22) Filed: Mar. 12, 2024

Related U.S. Application Data
(60) Provisional application No. 63/580,128, filed on Sep. 1, 2023.

(51) Int. Cl. E05B 83/02

(52) U.S. Cl. CPC E05B 83/02

(57) ABSTRACT

A latch assembly for a spreader on a truck. The latch assembly includes a latch that is rotatable. A tab is located on one of the latch or a spreader plate member. A slot is defined by one of the spreader plate member or latch. In a first position of the latch, the tab extends at least partially through the slot preventing rotation of the latch.

### CROSS-REFERENCE TO RELATED PATENT APPLICATIONS

This patent application claims the benefit of U.S. Provisional Patent Application No. 63/580,128, filed Sep. 1, 2023, the entire teachings and disclosure of which are incorporated herein by reference thereto.

### FIELD OF THE INVENTION

This invention generally relates to spreaders and more particularly to spreaders on trucks.

### BACKGROUND OF THE INVENTION

PRIOR ART FIG. 6 shows a spreader 10 of the prior art used on trucks 12. Bed 14 of the truck 12 lifts to feed the material into the spreader 10 where an auger 16 (PRIOR ART FIG. 7) directs the material to a spinner 17 or a berm chute as desired. The material may be, for example, salt that is spread by the spinner 17 on the street or other pavement to prevent or melt ice. The material may be sand which can also be spread on the street to improve driving conditions or prevent undesirable driving conditions. The material might also be aggregate, that might be spread via the berm chute to build up a shoulder on the side of the road. The spreaders 10, from time to time, may require maintenance to ensure the auger 16 (PRIOR ART FIG. 7) is properly maintained. During operations, for example a snowstorm, where salt is being spread, spreader 10 may jam which requires access to the auger 16 (PRIOR ART FIG. 7).

With respect to PRIOR ART FIGS. 6 and 7, a top panel 18 of the spreader is usually open during operation and therefore is off limits to an operator when trying to clear a jam. Instead, a bottom trough 20 that is hingedly connected to the spreader 10 can be opened. The bottom trough 20 many have one side that is hingedly connected to the spreader body 22 and an opposite, unhinged side may have latches 24, 26 that clamp the second side to the spreader body 22. When the latches 24, 26 are moved to unclamp the second side, the bottom trough 20 pivots open about the axis of the hinged side thereby opening the bottom of the spreader body 22.

The bottom trough 20, even though hingedly connected to the spreader 10, is very heavy and long such that it is cumbersome to open. Indeed, when opened, there is concern on the part of an operator that the hinged bottom trough 20 may suddenly swing open and possibly strike the operator or that the material within the bottom trough 20 may suddenly fall to the ground or on the operator. To avoid this, as shown in PRIOR ART FIG. 8, the operator uses both hands, one on the bottom trough 20 to prevent a sudden opening and the other hand on the latch 24 to unclamp the bottom trough 20.

Returning then to PRIOR ART FIG. 6, latch 24 is rotated and then latch 26 is rotated to unclamp the unhinged end of the bottom trough 20. This is done with much caution out of concern that the bottom trough 20 will suddenly open. Operators prefer to avoid this scenario and use a second operator to hold the bottom trough 20 while the other operator rotates the latches 24, 26. Alternatively, one operator works at one end of the bottom trough 20 where latch 24 is located, and the other operator works at the other end of the bottom trough 20 where latch 26 is located. However, while two operators are preferred, in the field, typically only one operator is present at the truck 12 such that opening the bottom of the bottom trough 20 may not be possible, given its weight and the awkwardness of trying to hold it while also trying to manipulate latches 24, 26 that might be partially frozen, for example in a winter storm.

Bottom trough 20 is heavy because of its metal construction and because it is a trough which collects the material in it to be moved by the auger 16 within the bottom trough 20. A bottom trough 20 that is constructed of metal and filled with salt or sand or aggregate is heavy and long such that one operator can have extreme difficulty in trying to hold the bottom trough 20 closed or allowing it to slowly hinge open.

Once the maintenance or jam inside the spreader body 22 and the auger 16 (PRIOR ART FIG. 7) has been addressed, as seen in PRIOR ART FIG. 8, the operator uses one hand to lift the bottom trough 20 while the other hand is on the latch 24 to rotate into position to clamp the bottom trough 20 to the spreader body 22. The lift is difficult due to the weight of the bottom trough 20 and its length. As illustrated, typically, the average sized operator must use both hands to lift the bottom trough 20. Next, the operator moves to the other end of the spreader 10 to move the latch 26 (PRIOR ART FIG. 6) to complete the clamping of the bottom trough 20 to the spreader body by rotating the latch 26 (PRIOR ART FIG. 6) into position. Given the difficulty in closing the bottom trough 20, at times, operators must leave the field of operations and return to a facility for assistance.

In a prior art embodiment, as seen in PRIOR ART FIG. 9, the latch 24 includes a retention assembly 28 that consists of a block 30 attached to the spreader body 22 via weldment. The retention assembly 28 is also present with latch 26 (PRIOR ART FIG. 6) and is the same structure. Therefore, while retention assembly 28 of latch 24 will be described the same retention assembly 28 is also present with latch 26 (PRIOR ART FIG. 6).

The block 30 includes an aperture 32 through which a spring 34 is inserted. The spring 34 is closed to surround a retention member 36. Once the spring 34 surrounds the retention member 36, then at least that side of bottom trough 20 (PRIOR ART FIG. 8) has been safely clamped to the spreader body 22 and the latch 24 cannot freely rotate without rotating spring 34 off the retention member 36. Thus, as previously discussed, it is not enough for the operator merely to rotate the latch 24 to open or close the bottom trough 20 (PRIOR ART FIG. 8). Instead, the operator must not only rotate latch 24, but must also secure the retention assembly 28 to prevent any unwanted rotation of the latch 24. Therefore, it takes two steps for the operator to rotate the latch 24 into its clamped or unclamped positions and then secondly, the operator must rotate spring 34 over the retention member 36 either to surround it in the secured position or remove it from retention member 36 to unsecure it to open the bottom trough 20 (PRIOR ART FIG. 8).

These two steps, given the current design of prior art latches 24, 26, (PRIOR ART FIG. 6) is most efficiently done with two hands. This means that operators prefer having two operators present when opening or closing the bottom trough 20 (PRIOR ART FIG. 8). One operator facilitates the lift of the heavy bottom trough 20 (PRIOR ART FIG. 8) while the other operator frees the spring 34 from the retention member 36 and then turns the latch 24, 26 (PRIOR ART FIG. 6).

Also, the prior art latch design 24, 26 may be problematic as production costs for the latches 24, 26 with retention assembly 28 are higher than desired. This is particularly true if the block 30 is mistakenly welded to the wrong position or upside down on the spreader body 22. Also, it has been found that the spring 34 can free itself from the aperture 32 in the block 30. Operators are frequently engaged in operations with the spreader 10 in winter storms and the manipulation of the spring 34 that can be “stuck” from freezing and/or that works itself free is problematic. Therefore, depending on the amount of material in the bottom trough 20 (PRIOR ART FIG. 8), a single operator might be able to lift the bottom trough 20 (PRIOR ART FIG. 8) into position and then with one hand rotate the latch 24, 26 into its clamping position. Thereafter, a second step is required by the operator to secure the latch 24, 26 with the retention assembly 28.

Other prior art latches are also problematic given their complex designs and large number of parts that are subject to freezing and/or require two hands to operate.

### BRIEF SUMMARY OF THE INVENTION

The invention provides an improved spreader because of improved latch assemblies. The improved latch assemblies decrease the number of parts used, lower production costs, and allow an operator to secure and unsecure the unhinged side of the bottom trough from the spreader body, turn the latch, and thereby open or close the bottom trough for access to the auger with one hand and in one step. So too the latches according to the teachings of the instant invention permit the operator, in one step instead of two, to close and secure the bottom trough to the spreader body. These and other advantages of the invention, as well as additional inventive features, will be apparent from the description of the invention provided herein.

In one aspect, the invention provides a latch assembly for a spreader on a truck. The latch assembly includes a latch that is rotatable. A tab is located on one of the latch or a spreader plate member located on the spreader. A slot is defined by one of the spreader plate member or latch. In a first position of the latch, the tab extends at least partially through the slot preventing rotation of the latch.

In another aspect, the invention provides a spreader for a truck. The spreader includes a spreader body defining a cavity surrounding the auger. The spreader body includes a top, a rear cross member, and a bottom trough. The bottom trough includes a first side hingedly connected to the spreader body and a second side opposite the first side. The spreader includes a latch assembly having a latch that is rotatable. A tab extends from one of the latch and a spreader plate member. A slot is defined by one of the latch or spreader plate member. In a first position of the latch, the tab extends into the slot preventing rotation of the latch and the latch clamps the second side of the bottom trough to the spreader body.

In an embodiment, pulling the latch removes the tab out of the slot such that the latch is free to rotate to a second position where the tab does not extend through the slot.

In an embodiment, the latch has a latch body, the latch body has a first end opposite a second end. A handle member and tab extend from the first end and an aperture defined by the latch body is at the second end.

In an embodiment, a pin extends through a spreader plate member aperture and the aperture of the latch body to provide a latch axis of rotation about which the latch rotates.

In an embodiment, the tab is located on the latch body and extends away from the latch body in a first direction and the handle member extends away from the latch body in a second direction. The first direction and the second direction are not the same directions.

In an embodiment, the tab is located on the latch and the slot is defined in the spreader plate member.

In an embodiment, the tab is located on the spreader plate member and the slot is defined in the latch.

In an embodiment, in the first position of the latch assembly, a portion of the bottom trough is sandwiched between an abutment element of the latch and at least a section of the rear cross member of the spreader body.

In an embodiment, pulling down on the latch removes the tab from the slot such that the latch is free to rotate in a second rotational direction.

In an embodiment, rotation of the latch in the first rotational direction to a second position allows the bottom trough to pivot about the first side that is hinged such that the portion of the bottom trough is not sandwiched between the abutment element and the at least a section of the front cross member.

In an embodiment, the latch is rotated in a second rotational direction opposite the first rotational direction to place the latch in the second position.

In an embodiment, the latch assembly includes a pin extending through an aperture of the spreader plate member and an aperture in the latch to provide a latch rotational axis about which the latch rotates.

In an embodiment, a second latch assembly is spaced apart from the latch assembly on the spreader body. The second latch assembly has a second latch that is rotatable. A second tab extends from one of the second latch or second spreader plate member, and a second slot is defined by one of the second latch or second spreader plate member. In a first position of the second latch, the second tab extends into the second slot preventing rotation of the second latch and the second latch clamps the second side of the bottom trough to the spreader body.

In yet another aspect, the invention provides a method for opening and closing a bottom trough hingedly connected at a first side of the bottom trough to a spreader body of a spreader. The opening provides access to an auger from a bottom of the spreader body. The method includes the step of rotating a latch assembly in a first rotational direction to position a tab of the latch assembly in extension through a slot of the latch assembly.

In an embodiment, the method includes the step of clamping a second side opposite the first side of the bottom trough between the spreader body and an abutment element of the latch to close the bottom trough against the spreader body.

In an embodiment, the method includes the step of pulling on the latch to remove the tab from the slot.

In an embodiment, the method includes the step of rotating the latch in a second rotational direction that is opposite the first rotational direction to unclamp the second side of the bottom of the trough, leaving it free to pivot open about the first side that is hingedly connected to the spreader body.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of a spreader with a closed bottom trough and with a pair of latch assemblies in a first position according to the teachings of the instant invention;

FIG. 2 is an enlarged view of one of latch assemblies of FIG. 1;

FIG. 3 is an isometric view of the spreader of FIG. 1 with an open bottom trough and with the pair of latch assemblies in a second position;

FIG. 4 is an enlarged view of one of the latch assemblies of FIG. 3;

FIG. 5 is a cross section taken about line 5-5 of FIG. 1;

FIG. 6 is a prior art view of a truck with a spreader;

FIG. 7, illustrates an auger in the prior art spreader of FIG. 6;

FIG. 8 illustrates an operator lifting a bottom trough and rotating a latch of the prior art spreader of FIG. 6; and

FIG. 9 illustrates the latch in a first position on the prior art spreader of FIG. 6.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

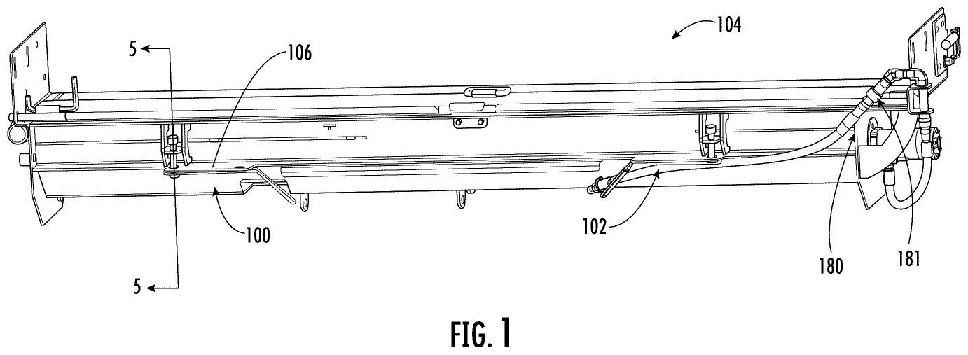

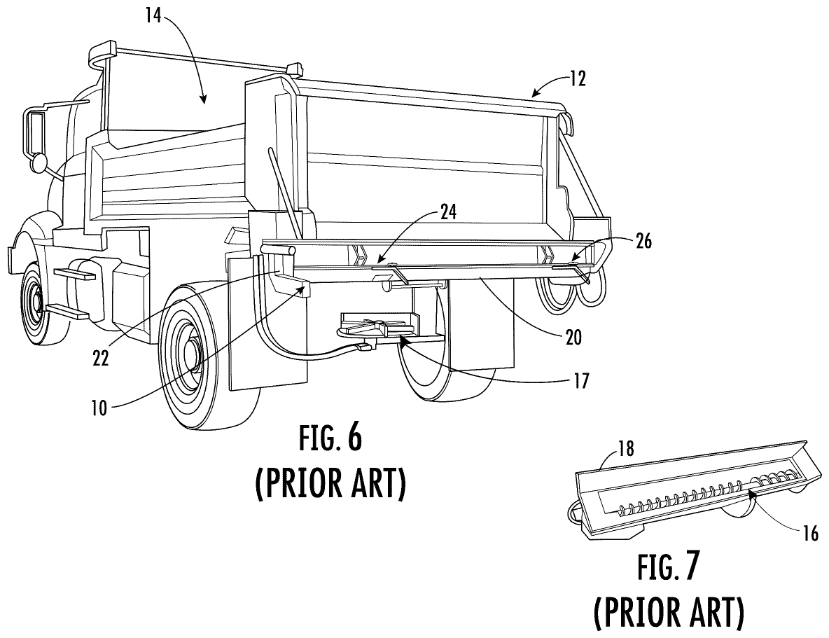

FIG. 1 illustrates a pair of latch assemblies 100, 102 for a spreader 104 on a truck 12 (FIG. 6). Each latch assembly 100, 102, is structurally the same and therefore, only latch assembly 100 will be described with the understanding that said description is applicable to latch assembly 102.

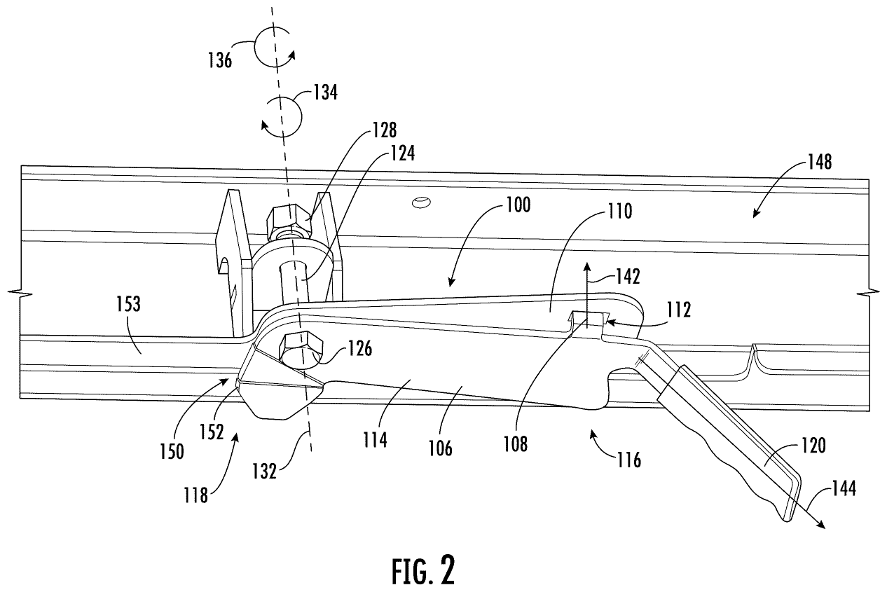

Turning to FIG. 2, the latch assembly 100 includes a latch 106 that is rotatable. A tab 108 extends transversely away from the latch 106. The latch assembly 100 includes a spreader plate member 110 defining a slot 112. While the tab 108 is shown located on the latch 106 it can be readily appreciated that in an embodiment, the tab 108 can be present on spreader plate member 110 and the slot 112 can be defined by the latch 106 instead of the spreader plate member 110. Thus, while the description to follow describes the embodiment wherein the tab 108 is located on the latch 106 and the slot 112 is defined in the spreader plate member 110, the reverse of these locations is readily understood in light of the description to follow.

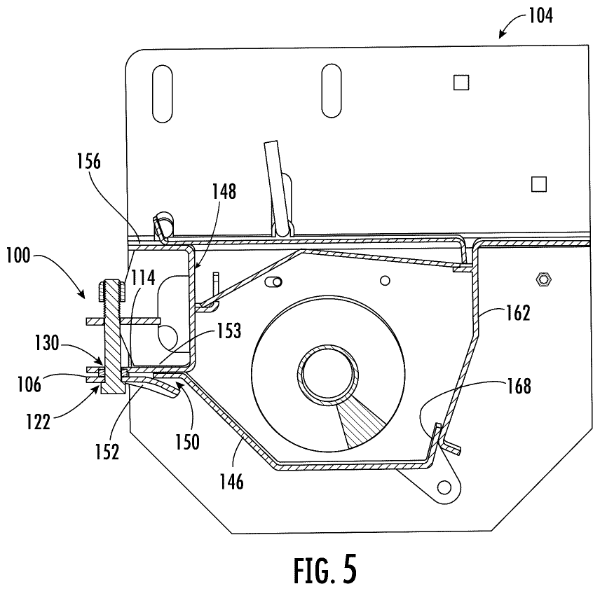

The latch 106 is shown in a first position wherein the tab 108 extends at least partially through the slot 112 preventing rotation of the latch 106. The latch 106 has a latch body 114. The latch body 114 has a first end 116 opposite a second end 118. A handle member 120 and the tab 108 extend from the first end 116. An aperture 122 (FIG. 5) defined by the latch body 114 is at the second end 118.

A bolt 124 having a bolt head 126 and nut 128 on opposite ends of the bolt 124 extends through a spreader plate member aperture 130 (FIG. 5) and the aperture 122 (FIG. 5) of the latch body 114 to provide a latch axis of rotation 132 about which the latch 106 rotates in a first rotational direction 134 and a second rotational direction 136 opposite the first rotational direction 134. While a bolt 124 is illustrated, it is not the intent to limit use to a bolt 124 and nut 128, as other means are envisioned, for example a pin and retainer such as a cotter pin.

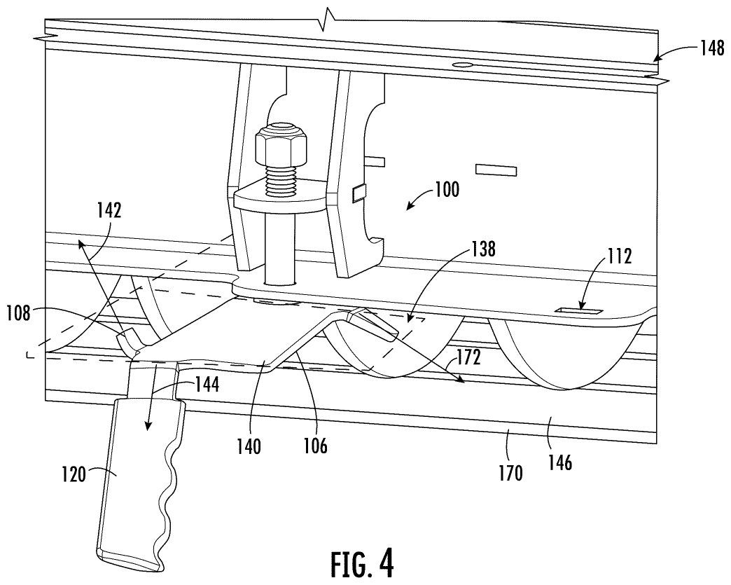

The tab 108 extends away from a plane 138 (FIG. 4) defined by a top surface 140 (FIG. 4) of the latch body 114 in a first direction 142. The handle member 120 extends away from the latch body 114 in a second direction 144. The first direction 142 and the second direction 144 are not the same directions and extend transversely away from the plane 138 (FIG. 4).

Pulling the handle member 120, approximately in the second direction 144, pulls the tab 108 out of the slot 112 such that the latch 106 is free to rotate to a second position (FIG. 4) where the tab 108 does not extend through the slot 112. In this instance only, “approximately” with respect to the “pulling,” it should be readily apparent that the pull may be with 90 degrees or more of the second direction 144 as a pulling or downward force exerted on the handle member 120 can remove the tab 108 from within the slot 112 such that the latch 106 is free to rotate in the first rotational direction 136.

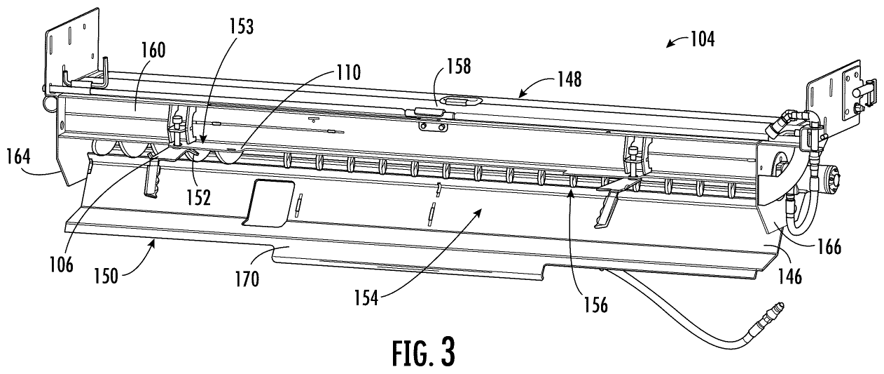

Those skilled in the art will recognize, at this point in the disclosure, the importance of the tab 108 in the slot 112 preventing the latch 106 from rotating. This prevents an unwanted rotation of the latch 106 that would open a bottom trough 146 (FIG. 3) of the spreader 104 and possibly exposing the operator to an auger 156 (FIG. 3) that may be rotating or in tension or an unwanted spill of material from the spreader 104. So too, those skilled in the art will recognize, a hydraulic interlock with a hydraulic coupler first end 180 (FIG. 1) and a hydraulic coupler second end 181 kills power to the auger 156 prior any opening of the bottom trough 146 (FIG. 3). An interlock is integral to most designs, although they may not be a hydraulic quick coupler as shown in FIG. 1.

Therefore, it is readily appreciated that it is not enough to rotate the latch 106 to clamp the bottom trough 146 (FIG. 3) to the spreader. The latch 106 must be “locked” or “secured” such that it cannot rotate. According to the teachings of the invention, the latch assembly 100 provides the required clamping force to the bottom trough 146 (FIG. 3) and can also be locked in place via the tab 108 and slot 112 in one step. That is the rotation of the latch 106 both moves the latch 106 into its clamping position and its locked position that is the first position with the tab 106 extending a least partially in slot 108.

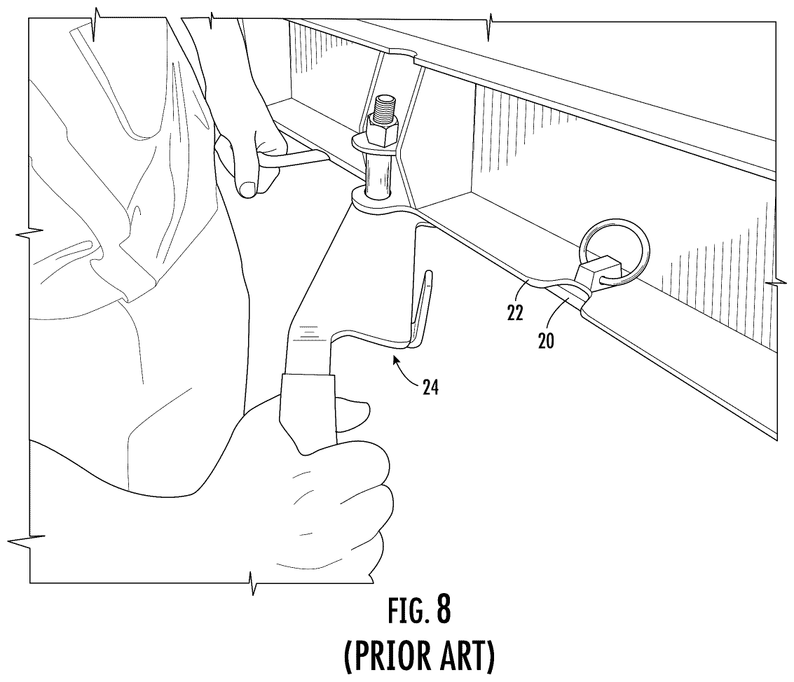

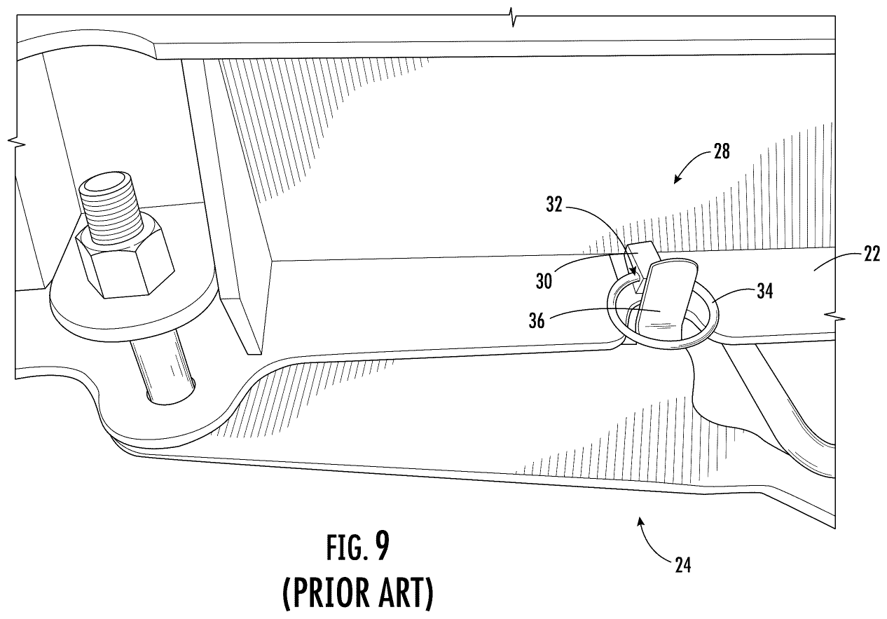

This means the present invention eliminates a step that was required in the prior art latches like latch 24 (FIG. 6). Namely, in the prior art, for example, latch 24 (FIG. 6) is rotated into position, and then the next step of securing the latch 24 (FIG. 9) is performed by the operator. This step might be for example, as discussed with spring 34 (FIG. 9), the operator must place the spring 34 over the retention member 36 (FIG. 8). Other prior art latches also had securing or locking assemblies that required this further step.

However, as seen in FIG. 2, in the instant invention, by rotation of the latch 106 alone, the tab 108 extends into the slot 112 and locks the latch 106 in place such that only one step is required to both rotate the latch to clamp the bottom trough 146 and lock the latch 106 in its first position. This differs from the prior art, which required the two steps, rotation of the latch 24 (FIG. 8), and then the second step of securing the latch 24 (FIG. 9).

FIGS. 2 and 5 illustrate the clamping feature provided by the latch assembly 100. In the first position of the latch 106, as discussed above, the bottom trough 146 through which the material moves is clamped against the spreader body 148 of the spreader 104 (FIG. 1). More specifically, in the first position of the latch 106, a portion 150 that may be an outer peripheral edge of the bottom trough 146 is sandwiched between an abutment element 152 of the latch 106 and at least a section 153 of a front cross member 156 of the spreader body 148. The abutment element 152 extends in a direction 172 (FIG. 4) transverse to the plane 138 (FIG. 4) of the latch body 114. Directions 142 (FIG. 4), 144 (FIG. 4), and 172 (FIG. 4) extend in directions that are transverse to one another, with no two directions ever parallel or perpendicular to one another, although, in other embodiments, the directions 142 (FIG. 4), 144 (FIG. 4), 172 (FIG. 4) may extend generally parallel or perpendicular to one another, for example tab 108 (FIG. 4) and handle member 120 (FIG. 4) may extend in directions parallel to one another and so on as readily appreciated and understood by those skilled in the art. However, the directions of extension shown 142 (FIG. 4), 144 (FIG. 4), and 172 (FIG. 4) are preferred for use by an operator.

Turning to FIG. 3, the spreader 104 has the spreader body 148 which defines cavity 154 surrounding auger 156. The spreader body 148 includes a top 158, a rear cross member 160, a front cross member 162 (FIG. 5), the bottom trough 146, and a first endplate 164 and a second endplate 166. The bottom trough 146 includes a first side 168 (FIG. 5) hingedly connected to the spreader body 148 and a second side 170 opposite the first side 168 (FIG. 5).

In FIG. 3, the latch 106 has been rotated in the first rotational direction 136 (FIG. 2) to a second position. This allows the bottom trough 146 to pivot about an axis defined by the first side 168 (FIG. 5) that is hinged such that the portion 150 of the bottom trough 146 is not sandwiched between the abutment element 152 and the at least a section 153 of the rear cross member 160. The section 153 may be provided by the spreader plate member 110 that is integral, meaning formed as part of the rear cross member 160. Alternatively, the spreader plate member 110 may be a separate element fixed to the rear cross member 160 by various known means, for example weldment or fasteners. As shown in FIG. 3, the spreader plate member 110 is integral with the rear cross member 160.

FIG. 4 illustrates the latch 106 in its second position wherein the bottom trough 146 is hingedly connected to the spreader body 148, but the tab 108 of the latch 106 is free of the slot 112 and the latch 106 is not clamping the second side 170 of the bottom trough 146 and therefore it has pivoted open, to open the cavity 154 (FIG. 3) for access to the auger 156.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred.

Embodiments may become apparent to those of ordinary skill in the art upon reading the foregoing description The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A latch assembly for a spreader on a truck, the latch assembly comprising:
a latch that is rotatable;
a tab located on one of the latch or a spreader plate member;
a slot defined by one of the spreader plate member or latch;
wherein in a first position of the latch, the tab extends at least partially through the slot preventing rotation of the latch.

2. The latch assembly of claim 1, where pulling the latch removes the tab out of the slot such that the latch is free to rotate to a second position where the tab does not extend through the slot.

3. The latch assembly of claim 2, wherein the latch has a latch body, the latch body having a first end opposite a second end, a handle member and extends from the first end and an aperture defined by the latch body is at the second end.

4. The latch assembly of claim 3, wherein a pin extends through a spreader plate member aperture and the aperture of the latch body to provide a latch axis of rotation about which the latch rotates.

5. The latch assembly of claim 1, wherein the tab is located on the latch body and extends away from the latch body in a first direction and the handle member extends away from the latch body in a second direction, the first direction and the second direction are not the same directions.

6. The latch assembly of claim 1, wherein the tab is located on the latch and the slot is defined in the spreader plate member.

7. The latch assembly of claim 1, wherein the tab is located on the spreader plate member and the slot is defined in the latch.

8. A spreader for a truck, the spreader comprising a spreader body defining a cavity surrounding the auger, the spreader body comprising a top, a rear cross member, and a bottom trough, the bottom trough comprising a first side hingedly connected to the spreader body and a second side opposite the first side, the spreader comprising;
a latch assembly having a latch that is rotatable, a tab extending from one of the latch and a spreader plate member;
a slot defined by one of the latch or spreader plate member;
wherein in a first position of the latch, the tab extends into the slot preventing rotation of the latch and the latch clamps the second side of the bottom trough to the spreader body.

9. The spreader of claim 8, wherein in the first position of the latch, a portion of the bottom trough is sandwiched between an abutment element of the latch and at least a section of the rear cross member of the spreader body.

10. The spreader of claim 8, wherein pulling down on the latch removes the tab from the slot such that the latch is free to rotate in a second rotational direction.

11. The spreader of claim 10, wherein rotation of the latch in the second rotational direction to a second position allows the bottom trough to pivot about the first side that is hinged such that the portion of the bottom trough is not sandwiched between the abutment element and the at least a section of the front cross member.

12. The spreader of claim 11, wherein the latch is rotated in a first rotational direction opposite the second rotational direction to place the latch in the first position.

13. The spreader of claim 8, the latch assembly comprising a pin extending through an aperture of the spreader plate member and an aperture in the latch to provide a latch rotational axis about which the latch rotates.

14. The spreader of claim 8, comprising a second latch assembly spaced apart from the latch assembly on the spreader body, the second latch assembly having a second latch that is rotatable, a second tab extending from one of the second latch or second spreader plate member, and a second slot defined by one of the second latch or second spreader plate member;
wherein in a first position of the second latch, the second tab extends into the second slot preventing rotation of the second latch and the second latch clamps the second side of the bottom trough to the spreader body.

15. A method for opening and closing a bottom trough hingedly connected at a first side of the bottom trough to a body of a spreader so as to provide access to an auger from a bottom of the spreader body, the method comprising the step of:
rotating a latch assembly in a first rotational direction to position a tab of the latch assembly in extension through a slot of the latch assembly.

16. The method of claim 15, further comprising the step of clamping a second side opposite the first side of the bottom trough between the spreader body and an abutment element of the latch to close the bottom trough against the spreader body.

17. The method of claim 16, further comprising the step of pulling on the latch to remove the tab from the slot.

18. The method of claim 16, further comprising the step of rotating the latch in a second rotational direction, opposite the first rotational direction to unclamp the second side of the bottom of the trough leaving it free to pivot open about the first side that is hingedly connected to the spreader body.
